(19) United States
(12) Patent Application Publication
(10) Pub. No.: US 2003/0168248 A1
(43) Pub. Date: Sep. 11, 2003

(54) Protective sleeving with support ribs

(76) Inventors: Marc R. Savoy, Manalapan, NJ (US); Brian M. Snyder, Downingtown, PA (US); Danny E. Winters, Downingtown, PA (US)

Correspondence Address: Synnestvedt & Lechner LLP, Suite 2600, 1101 Market Street, Philadelphia, PA, 19107-2950, US

(21) Appl. No.: 10/340,010

(22) Filed: Jan. 10, 2003

Related U.S. Application Data
(60) Provisional application No. 60/349,011, filed on Jan. 14, 2002.

(51) Int. Cl. H01B 7/24

(52) U.S. Cl. 174/136

(57) ABSTRACT

An elongated sleeve for protecting elongated substrates is disclosed. The sleeve has a flexible elongated backbone extending lengthwise along the sleeve. A plurality of flexible, resilient ribs extend transversely from the backbone. The ribs are biased into a concave, preferably circular shape to define a central space for receiving the substrates. The backbone may be continuous, discontinuous or split and may intersect the ribs at a point spaced from their mid point, defining asymmetrical ribs. One or more layers of material are attached to the ribs forming a covering which defines a lengthwise seam along the ends of the ribs providing access to the central space. The layers may be positioned on either or both inside or outside of the ribs. The layers may provide a reflective surface for thermal protection.

### RELATED APPLICATION

This application is based on and claims the benefit of U.S. Provisional Application No. 60/349,011, filed Jan. 14, 2002.

### FIELD OF THE INVENTION

This invention concerns sleeving for encasing and protecting elongated substrates, such as wiring harnesses, fuel lines, brake lines, optical fibers and like objects which are subjected to harsh physical environments.

### BACKGROUND OF THE INVENTION

Elongated substrates, such as wiring harnesses, fluid conduits, such as brake lines and fuel lines, and optical fiber bundles are often used in automotive, aerospace, marine and communication applications where they are subjected to harsh physical environments such as intense heat, vibration, physical impact, shock and abrasion.

Wiring harnesses and fuel lines routed through an enclosed engine compartment, for example, in an automobile, boat or aircraft, are subjected to prolonged and intense vibration as well as both radiant and convective heat from the engine, particularly the exhaust manifold. Similarly, fuel lines and wiring in the vicinity of a rocket engine nozzle or on an orbiting satellite are exposed to severe vibratory acoustical environments upon launch, as well as severe thermal environments when exposed to direct sunlight in the vacuum of space.

Even when subjected only to physical handling, it is advantageous to provide relatively delicate, elongated items such as optical fibers with an external sleeve which supports and protects them from physical damage, as well as excessive bending, pinching and kinking. Protection is necessary because the fibers are generally subject to physical damage due to impact, shock, abrasion, bending and kinking which can result from rough handling during installation, as well as conditions of service. Such environments can impose stress fields within the fibers which adversely affect the transmission of optical signals. Support and protection of the fibers prevents or mitigates excessive, damaging stresses on the fibers by limiting the radius of curvature which the optical fibers will experience; presenting a shield preventing pinching of the fibers between sharp edges, damping shock and vibratory disturbances; providing a preferred load path which relieves the optical fibers of any tensile or compressive loads; and preventing abrasive contact with the optical fiber bundle.

Protective sleeving for elongated substrates should be economical to produce, easy to incorporate into an existing layout or design, provide adequate protection against the expected environmental hazards and be flexible so as to follow the path of the substrate, yet not too flexible so as to prevent excessive bending and/or kinking of the substrate.

### SUMMARY OF THE INVENTION

The invention concerns an elongated sleeve for protecting elongated substrates. In its preferred embodiment, the sleeve comprises a flexible, elongated backbone oriented substantially lengthwise along the sleeve. A plurality of flexible, resilient ribs are each attached transversely (preferably perpendicularly) to the backbone in spaced relation to one another. The ribs are resiliently biased into a concave shape (preferably round) substantially coaxially with one another and thereby define a central space for protecting the elongated substrate. The sleeve also comprises one or more layers attached to the ribs. Each of the ribs has opposite ends positioned in proximity to one another. The layer or layers extend from end to end of each rib around the sleeve, either on the inside, outside or both inside and outside, to define a seam oriented lengthwise along the sleeve providing access to the central space. When the ends of the ribs are in overlapping proximity to one another, they form a closed seam lengthwise along the sleeve. The seam may be manually opened by deflecting the ribs outwardly to insert a length of substrate into the central space, the seam closing due to the resilient biasing of the ribs which move back into overlapping proximity when released.

Preferably, the backbone intersects each of the ribs at a point spaced away from the mid point of each rib. This asymmetrical configuration has been found to prevent the seam from opening by itself when the sleeve is bent or curved. The layer may be positioned on the outside of the sleeve with the ribs and the backbone positioned between the central space and the layer. Another layer may be positioned on the inside of the sleeve between the central space and the ribs with the ribs being sandwiched between the inner and outer layers.

For thermal protection, the outer layer comprises a reflective surface facing away from the central space so as to reflect radiant heat away from the substrate within the sleeve. For acoustic or vibratory protection, the inner layer comprises a foam or a felt lining for attenuating the vibratory energy.

In an alternate embodiment, the sleeve according to the invention does not include the backbone but comprises a plurality of flexible, resilient ribs, each being positioned in spaced relation to one another and oriented transversely to the long axis of the sleeve. As in the previous embodiment, the ribs are resiliently biased into a concave shape substantially coaxially with one another, thereby defining a central space for receiving the elongated substrate within the sleeve. The sleeve also comprises one or more layers attached to the ribs. Again, each of the ribs has opposite ends positioned in proximity to one another, and the layer or layers extend from end to end of each rib to a seam oriented lengthwise along the sleeve. The seam provides access to the central space for inserting and removing the substrate. The layers may be bonded to the ribs by pressure sensitive adhesive.

Other embodiments feature ribs connected to one another by a discontinuous backbone comprising a plurality of segments positioned on alternately on opposite sides of the seam wherein each backbone segment on one side of the seam is aligned with a space between ribs on the other side of the seam. In another alternate embodiment, the ribs are connected to one another by a backbone which is split longitudinally to define the seam.

### BRIEF DESCRIPTION OF THE DRAWINGS

FIG. 1 is a perspective view of an elongated sleeve according to the invention for protecting elongated substrates;

FIG. 1A is a partial cross-sectional view of the sleeve taken along lines 1A-1A of FIG. 1;

FIG. 2 is a cross-sectional view of the sleeve taken along lines 2-2 of FIG. 1;

FIG. 3 is a perspective view of another embodiment of an elongated sleeve according to the invention;

FIG. 4 is a perspective view of yet another embodiment of an elongated sleeve according to the invention;

FIG. 4a is a plan view of the ribs shown in FIG. 4 prior to biasing into a concave shape;

FIG. 5 is a perspective view of another embodiment of an elongated sleeve according to the invention;

FIG. 5a is a plan view of the ribs shown in FIG. 5 prior to biasing into a concave shape;

FIG. 6 is a flow chart illustrating steps of manufacture of an elongated sleeve according to the invention; and

FIG. 7 is a plan view of ribs as they appear in an intermediate manufacturing step for the embodiment shown in FIG. 3.

### DETAILED DESCRIPTION OF THE PRESENTLY PREFERRED EMBODIMENTS

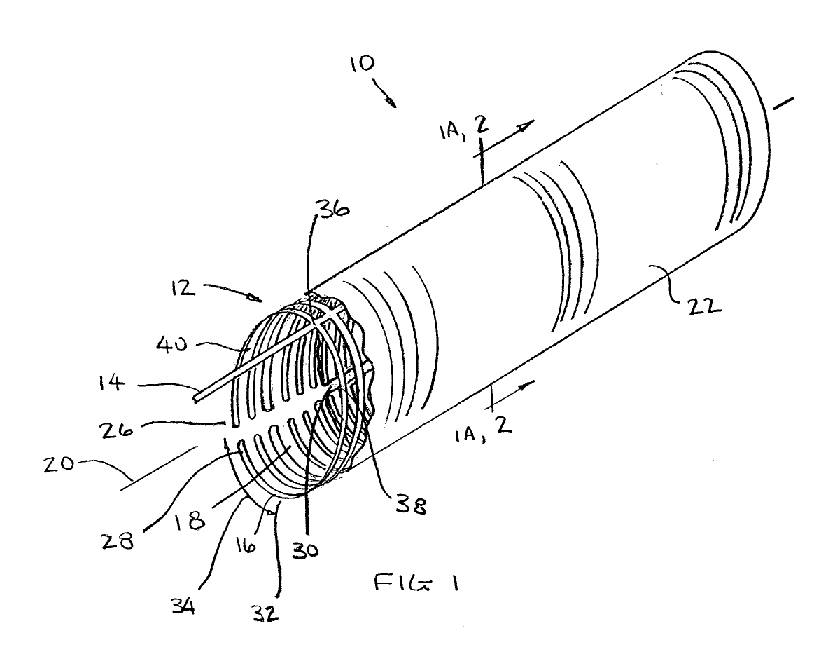

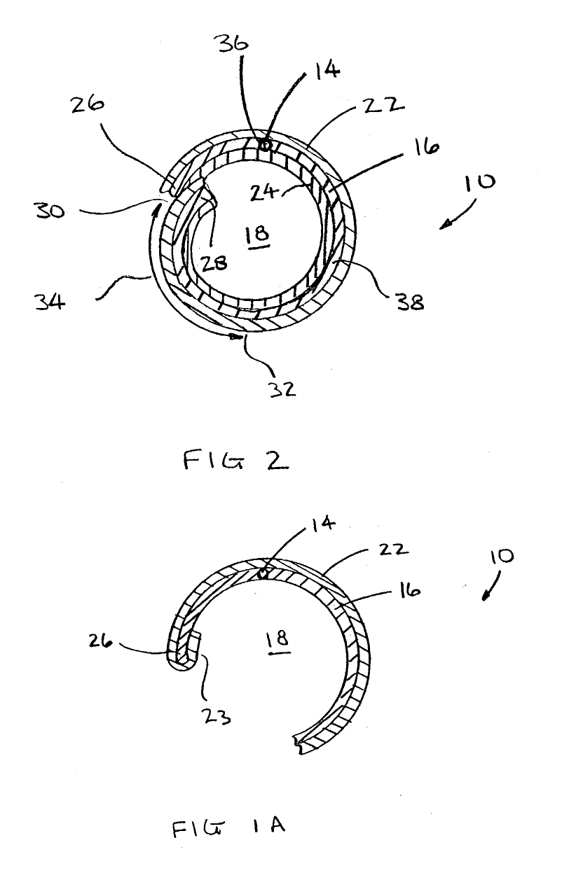

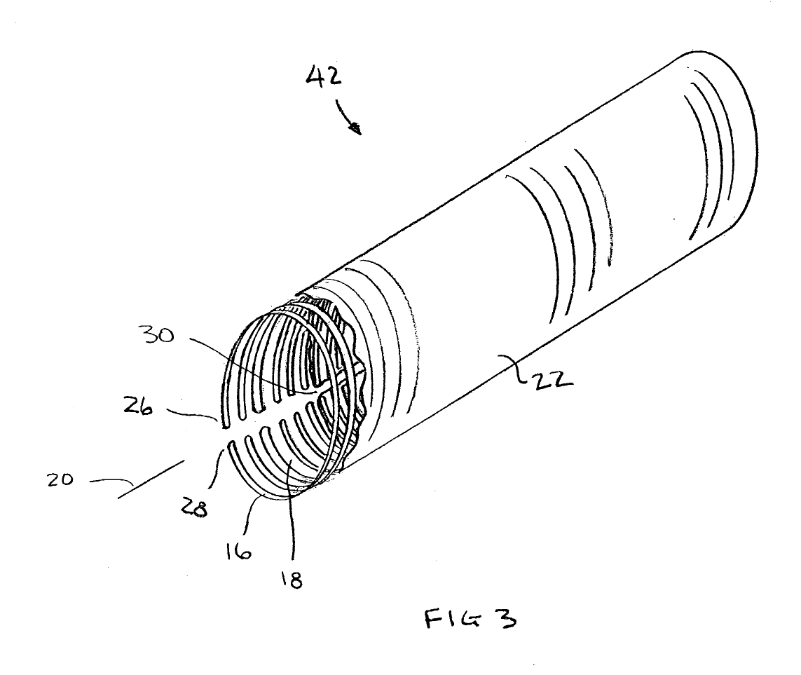

FIG. 1 shows an elongated sleeve 10 for protecting elongated substrates. Sleeve 10 has a support structure 12 comprising a flexible, elongated backbone 14 oriented substantially lengthwise along the sleeve 10. A plurality of ribs 16 are attached to the backbone 14. The ribs are oriented transversely of the backbone and preferably substantially perpendicular to it. Ribs 16 are arranged in spaced relation relatively to one another along the backbone and are resiliently biased into a concave shape defining a central space 18 for receiving the elongated substrate to be protected. Preferably, the ribs are substantially coaxially aligned with one another about a common longitudinal axis 20. A layer 22 is attached to the ribs 16, the characteristics and material of layer 22 being chosen to provide the type of protection desired for the expected environment to which the substrate will be subjected. In the embodiment shown in FIG. 1, layer 22 comprises the outermost layer of the sleeve 10, but another layer 24 may also be positioned within the support structure 12 as shown in FIG. 2. Layer 24 may be in addition to or instead of layer 22.

Each rib 16 has ends 26 and 28 which are positioned in proximity to one another, as shown in FIG. 1. Preferably, ends 26 and 28 of ribs 16 are biased into overlapping relationship as shown in FIG. 2 for reasons described below. Layers 22 and 24 preferably extend along ribs 16 from end 26 to end 28, and together, the ribs and layer or layers define a seam 30 which runs lengthwise along the sleeve 10. Seam 30 provides access to central space 18, and it is preferred to have the ends 26 and 28 of ribs 16 in overlapping relation so the seam remains closed during installation and service as described below.

Support structure 12 is preferably formed from a thermoplastic such as nylon. Other thermoplastics such as polypropylene and polyethylene are also feasible. Thermoplastics are advantageous because they are readily heat formable, allowing ribs 16 to be biased into the concave shape defining the central space 18. After forming, the thermoplastic material remains resilient and flexible, allowing the ribs 16 to be manually deformed for opening seam 30 to provide temporary access to the central space 18, the ribs 16 being biased to return to their concave shape upon release, thereby closing seam 30.

The elastic modulus, section properties and rib geometry and spacing determine the flexibility of the support structure 12. The ribs 16 provide the radial support which prevents the sleeve from collapsing under load, with thicker ribs yielding a greater crush resistance. The size and spacing of the ribs along the length of the sleeve determine its bending flexibility. Bending flexibility is an important parameter which must be properly limited if substrates having inherent permissible bending limits, such as optical fiber bundles, are to be carried by the sleeve 10. Generally, the width and spacing of the ribs are the important parameters controlling bending with large spacing of narrow ribs providing the greatest curvature of the sleeve.

When backbone 14 is present, the sleeve 10 is inhibited from bending in a direction which would place the backbone in compression. However, the sleeve will bend easily in a direction which will place the backbone in tension. Thus, the sleeve is asymmetrically stiff in bending due to the action of the backbone 14. It is further observed that if seam 30 is arranged diametrically opposite to backbone 14 then, upon bending, the seam 30 tends to open. As it is desirable for the seam to normally remain closed when the sleeve is bent or curved, it is preferred that the seam not be diametrically opposite to the backbone 14 but asymmetrically offset from the diametrical opposite point 32 as shown in both FIGS. 1 and 2. The offset 34 of the seam 30 from the point 32 is attained by having the backbone 14 intersect the ribs 16 at a point 36 spaced away from the middle 38 of each rib. This asymmetrical rib geometry results in ends 28 of the ribs 16 being further from the backbone 14 (as measured along the rib from the backbone to the end) than the ends 26 and 28 of the ribs but prevents the unintended opening of the seam 30 due to mere bending of the sleeve 10 because it shifts the position of seam 30 closer to the neutral axis of the tube where the compression stresses due to bending of the sleeve, which would normally cause the seam to buckle outward, are small and consequently have less effect on the seam. Biasing the ends 26 and 28 of the ribs into overlapping relation also contributes to preventing the seam 30 from opening inadvertently.

To afford radiant thermal or electromagnetic interference (EMI), protection outer layer 22 preferably comprises an aluminum foil layer laminated to a glass fiber fabric which is, in turn, laminated to ribs 16 with the reflective aluminum foil layer facing outwardly to reflect the incident thermal radiation. The glass fiber fabric is heat resistant and strengthens the foil layer, yet is flexible so as not to significantly stiffen the sleeve 10 in bending.

As shown in FIG. 1A, it is preferred to extend the layer 22 in an overwrap portion 23 which wraps around the ends 26 of ribs 16 and is attached along the inside of the ribs facing the central space 18. Use of the overwrap portion 23 helps prevent delamination of the layer 22 from the ribs, since there is no exposed edge of the layer 22 at which delamination can initiate. When layer 22 comprises the aluminum foil/glass fiber fabric for radiant thermal protection, the overwrap portion also protects the ends 26 of the ribs 16 from heat damage, as these ribs might otherwise be exposed to the heat.

EMI protection alone may be attained through the use of a wire mesh positioned either on the inside or outside of the support structure. For resistance to open flame rather than radiant heat, the outer layer 22 may be formed from a flame resistant or retardant polyester felt.

Acoustic or vibratory protection may be effectively attained through the use of foam or felt, preferably for inner layer 24 as shown in FIG. 2. Both foam and felt have excellent damping qualities and will absorb acoustic or vibratory energy and prevent a substrate within the sleeve central space 18 from responding to the incident energy. Layer 24 may also be a simple fabric liner, woven, braided or knitted from filamentary members comprising synthetics (polyester, nylon) or natural fibers (cotton, wool, linen) intended to close the spaces 40 between the ribs 16 to prevent the substrates from extending outwardly between the ribs and being pinched when the sleeve 10 is curved and the ribs are forced closer together on the concave (compression) side of the curve. The liner should be flexible so as to prevent undesired stiffening in bending. Knitted or braided fabrics are favored in this application due to their inherent flexibility, although woven fabrics comprising elastic filaments would also meet the requirements.

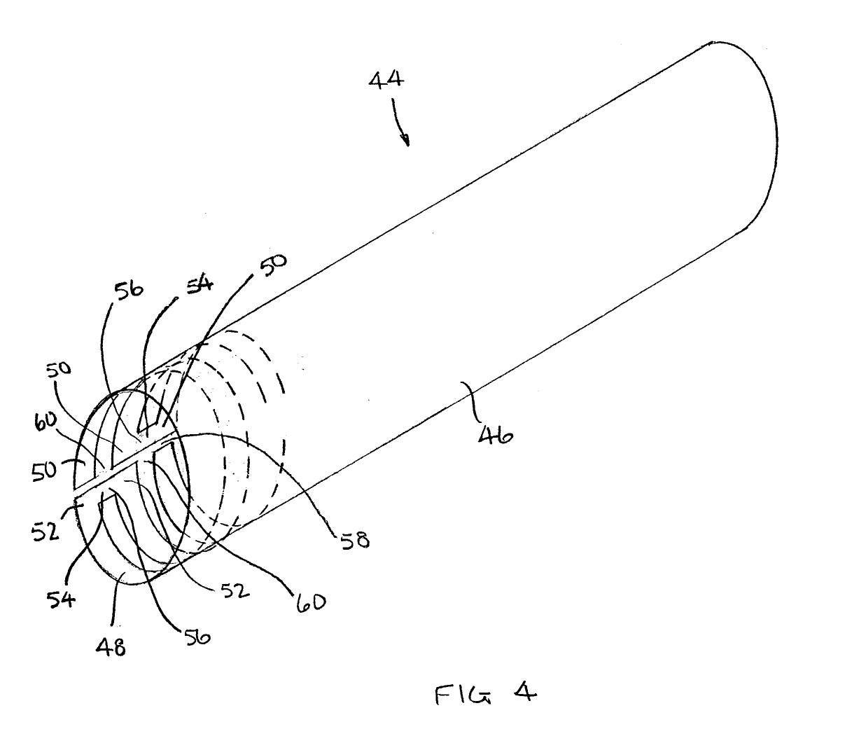

FIG. 3 shows an alternate embodiment of the sleeve 42 which does not have the backbone 14 as part of its support structure 12. Only ribs 16 are present. They are held in spaced relation coaxially with one another about the common axis 20 by the layer 22 to which they are attached. In this embodiment, ribs 16 are biased into a concave shape, preferably round, and have ends 26 and 28 in proximity to one another to define the seam 30 providing access to the central space 18 defined by the ribs and the layer for receiving the substrate to be protected. Sleeve 42 will generally bend equally readily in any direction because, lacking the backbone, it is generally symmetrically stiff about its longitudinal axis with the minor exception of the seam 30 which causes some small degree of asymmetry of the bending stiffness.

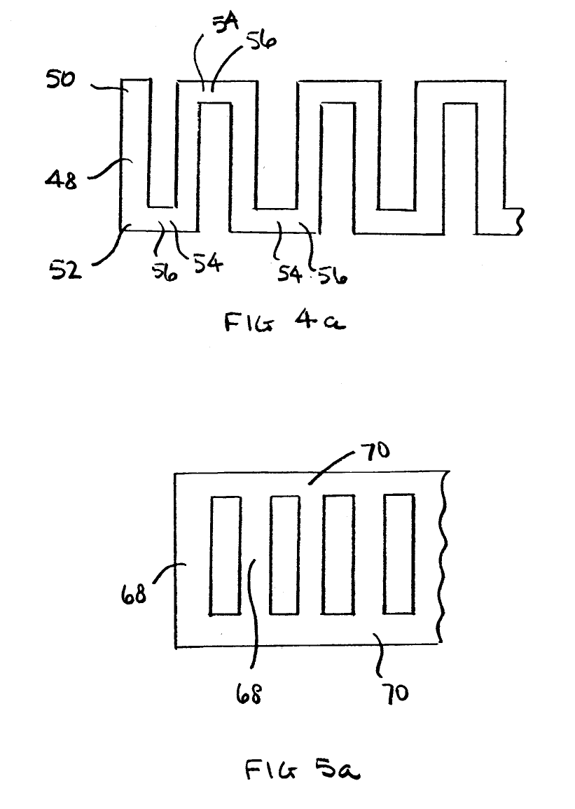

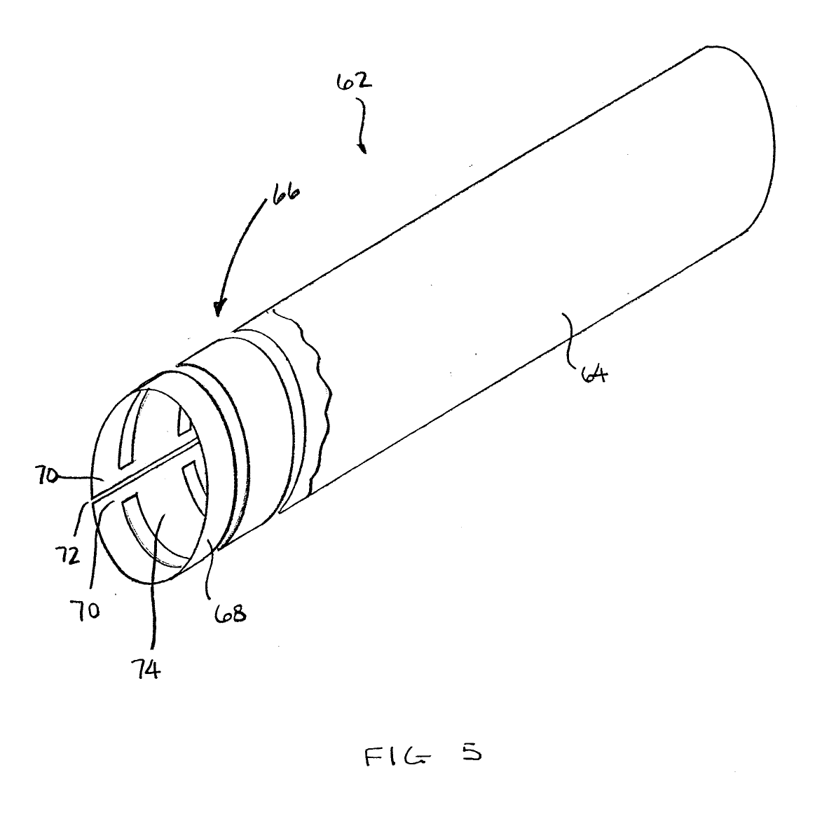

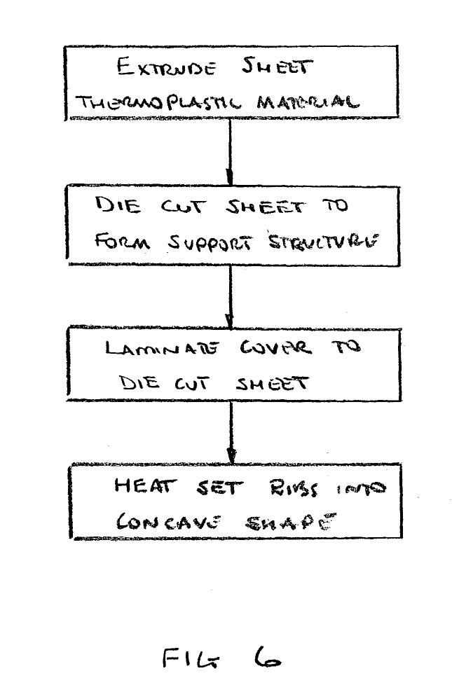

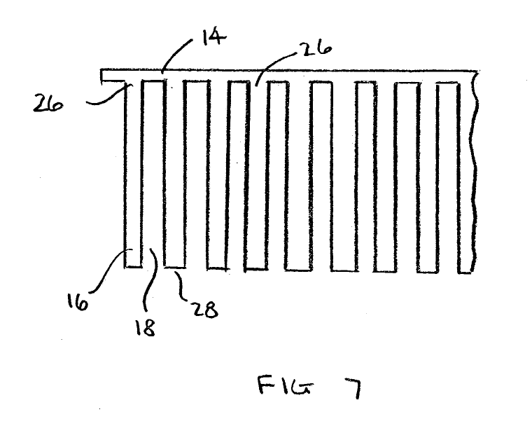

FIGS. 4, 4a, 5 and 5a show additional embodiments of the sleeve according to the invention having different support structures and being formed of substantially the same materials as described in the previous embodiments. FIG. 4 shows a sleeve 44 having a layer 46 and a plurality of ribs 48 having ends 50 and 52. The ribs 48 are arranged in spaced relation coaxially to one another lengthwise along sleeve 44. The ribs are connected by a discontinuous backbone 54 comprising a plurality of segments 56. The rib configuration alone is best shown in FIG. 4a which depicts the ribs in a plan view after being cut from a sheet of thermoplastic material but before being laminated with a layer and heat set into a concave shape. When the ribs are heat set, as shown in FIG. 4, the segments 56 are seen to connect ends 50 of adjacent ribs positioned on one side of a seam 58 and ends 52 of adjacent ribs positioned on the other side of the seam 58 in an alternating fashion, whereby each segment 56 on one side of the seam 58 is aligned with a space 60 on the opposite side of the seam. The curved ribs 48 provide the radial stiffness preventing the sleeve from collapsing and the spaced relation of the ribs allows for the desired bending flexibility.

FIG. 5 shows a sleeve 62 having a layer 64 and a support structure 66 comprising concavely curved ribs 68 arranged in spaced relation coaxially to one another lengthwise along the sleeve. The rib configuration alone is best shown in FIG. 5a which depicts the ribs in a plan view after being cut from a sheet of thermoplastic material but before being laminated with a layer and heat set into a concave shape. Ribs 68 are connected to one another by a backbone 70 which is split longitudinally and defines a seam 72 when the ribs are heat set into the curved shape as shown in FIG. 5. The seam 72 provides access to the central space 74 of the sleeve. Again, the spaced relation of the ribs provides for bending flexibility of the sleeve.

Manufacture of any of the sleeve embodiments described above is preferably accomplished in the steps described in the flow diagram of FIG. 6 by continuously extruding a sheet of thermoplastic material, die cutting the sheet to form the support structure (for example, ribs and backbone of the desired type), laminating the layer to the die cut sheet and then heat setting the ribs into their concave shape. The heat setting may be accomplished by applying heat to the flat laminated sheet and drawing the sheet through a forming die or over a mandrel and allowing the ribs to cool and form the desired shape.

Manufacture of the sleeve embodiment 42 shown in FIG. 3 without the backbone entails additional steps described below. As shown in FIG. 7, the ribs 16 are initially die cut from the thermoplastic sheet with a backbone 14 connecting the ribs to one another at one end 26, the ribs 16 extending from the backbone and resembling the tines of a comb. The presence of the backbone allows the ribs to be conveniently handled and continuously fed to a machine for laminating a layer or layers to the ribs without the need for any special tooling to hold individual ribs in the desired spaced relation as would be necessary if the ribs were not connected to the backbone. After the ribs are laminated, the backbone 14 is cut off and the laminated ribs, held in place by the layer or layers proceed to the machine which heat sets them into the concave shape depicted in FIG. 3. Alternatively, individual ribs may be directly laminated to the layer or layers by means of an indexing process using tooling to hold and space the ribs in position during lamination to the layer or layers.

The elongated sleeve according to the invention provides an inexpensive and versatile means for providing protection to any type of elongated substrate from the adverse effects of multiple environments, including heat, shock, vibration, abrasion, EMI, as well as stress due to tensile forces or excess curvature, while maintaining sufficient flexibility and resiliency to follow the path of the substrate and remain closed when desired and yet be readily openable along its longitudinal seam to provide access to the substrate.

What is claimed is:

1. An elongated sleeve for protecting elongated substrates, said sleeve comprising:
a flexible elongated backbone oriented substantially lengthwise along said sleeve;
a plurality of flexible, resilient ribs, each being attached transversely to said backbone in spaced relation to one another, said ribs being resiliently biased into a concave shape substantially coaxially with one another thereby defining a central space for receiving said elongated substrate therewithin; and
a cover attached to said ribs, each of said ribs having opposite ends positioned in proximity to one another, said cover extending from end to end of each rib and defining a seam oriented lengthwise along said sleeve providing access to said central space.

2. A sleeve according to claim 1, wherein said ribs are oriented substantially perpendicularly to said backbone.

3. A sleeve according to claim 2, wherein said backbone intersects each of said ribs at a point spaced away from the mid point of each rib.

4. A sleeve according to claim 1, wherein said ribs and said backbone are positioned between said central space and said cover.

5. A sleeve according to claim 4, wherein said cover comprises a reflective surface facing away from said central space.

6. A sleeve according to claim 4, wherein said cover is adhesively bonded to said ribs and said backbone.

7. A sleeve according to claim 1, wherein said ends of said ribs are in overlapping proximity to one another, thereby forming a closed seam lengthwise along said sleeve.

8. A sleeve according to claim 1, wherein said concave shape is substantially round.

9. An elongated sleeve for protecting elongated substrates, said sleeve comprising:
a plurality of flexible, resilient ribs, each being positioned in spaced relation to one another and oriented transversely to the long axis of said sleeve, said ribs being resiliently biased into a concave shape substantially coaxially with one another thereby defining a central space for receiving said elongated substrate therewithin; and
a cover attached to said ribs, each of said ribs having opposite ends positioned in proximity to one another, said cover extending from end to end of each rib and defining a seam oriented lengthwise along said sleeve providing access to said central space.

10. A sleeve according to claim 9, wherein said ribs are oriented substantially perpendicularly to said long axis of said sleeve.

11. A sleeve according to claim 9, wherein said ribs are positioned between said central space and said cover.

12. A sleeve according to claim 11, wherein said cover comprises a reflective surface facing away from said central space.

13. A sleeve according to claim 11, wherein said cover is adhesively bonded to said ribs and said backbone.

14. A sleeve according to claim 9, wherein said ends of said ribs are in overlapping proximity to one another, thereby forming a closed seam lengthwise along said sleeve.

15. A sleeve according to claim 9, wherein said concave shape is substantially round.
